(19) United States
(12) Patent Application Publication
(10) Pub. No.: US 2023/0120824 A1
(43) Pub. Date: Apr. 20, 2023

(54) Blade Hinge Assembly

(71) Applicant: Andis Company, Sturtevant, WI (US)

(72) Inventor: Edwin A. Werner, Union Grove, WI (US)

(21) Appl. No.: 18/145,269

(22) Filed: Dec. 22, 2022

Related U.S. Application Data
(63) Continuation of application No. PCT/US2021/038890, filed on Jun. 24, 2021.
(60) Provisional application No. 63/044,118, filed on Jun. 25, 2020.

(51) Int. Cl. B26B 19/20; B26B 19/06

(52) U.S. Cl. CPC B26B 19/205; B26B 19/06

(57) ABSTRACT

An adjustable blade attachment is provided that captures an inner blade relative to the outer blade. A mounting bracket captures the inner blade and provides access to attach the blade assembly. A hinge or metallic stamping extends through the mounting bracket and is adjustable to change the force exerted on the mounting bracket. The adjustment to hinge on the mounting bracket changes the tensile force between the inner and outer blade of the blade assembly. In this way, the hinge provides an adjustable component that can increase or decrease the tensile force exerted between the inner and outer blade to adjustably separate the inner and outer blades and reduce friction during operation of the blade assembly.

### CROSS-REFERENCE TO RELATED PATENT APPLICATIONS

The present application is a continuation of International Application No. PCT/US2021/038890, filed Jun. 24, 2021, which claims the benefit of and priority to U.S. Provisional Application No. 63/044,118, filed on Jun. 25, 2020, which are incorporated herein by reference in their entireties.

### BACKGROUND OF THE INVENTION

The present invention relates generally to the field of hair clippers or a hair cutting apparatus. The present invention relates specifically to an adjustable tensioning assembly configured to adjust a blade gap between a reciprocating blade and a stationary blade of a blade assembly.

### SUMMARY OF THE INVENTION

One embodiment of the invention relates to a blade hinge assembly, for example on a hair trimming device or cutter. The blade assembly includes an inner blade, an outer blade, a mounting bracket and a metallic stamping. The inner blade and outer blade include blade teeth. The outer blade teeth are oriented parallel to the inner blade teeth. The teeth are configured to facilitate cutting when the inner blade oscillates over the outer blade. The mounting bracket has plastic tabs and is coupled to an inner surface of the inner blade. The mounting bracket presses the inner blade against the outer blade to capture the inner blade against the outer blade. The metallic stamping is coupled to the inner surface of the inner blade and extends through the mounting bracket adjacent to the plastic tabs. The metallic stamping has snap tabs that are adjacent to and couple to the plastic tabs of the mounting bracket to generate an adjustable tensile force that pulls the mounting bracket away from the inner blade.

Another embodiment of the invention relates to a blade attachment assembly with an inner blade, an outer blade, a mounting bracket and a hinge. The inner and outer blades have a plurality of blade teeth. The mounting bracket has plastic tabs and is joined to an inner surface of the inner blade to press the inner blade against the outer blade and capture the inner blade as the blade oscillates. The hinge connects an inner surface of the inner blade to an inner surface of the mounting bracket (e.g., passes through the mounting bracket). The hinge has a spring constant between 0.1 and 4 lbf/in (e.g., a spring rate between 0.25 and 10 in/lbf) to change the tensile force of the mounting bracket and adjust the inner blade relative to the outer blade.

Another embodiment of the invention relates to an adjustable blade attachment assembly with an inner blade, an outer blade, a mounting bracket and a metallic stamped hinge. The inner and outer blades have blade teeth that are oriented parallel to facilitate cutting when the inner blade oscillates over the outer blade. The mounting bracket has plastic snap tabs and is coupled to an inner surface of the inner blade to press the inner blade towards the outer blade and capture the inner blade. The hinge joins an inner surface of the inner blade to an inner surface of the mounting bracket and has a spring constant between 0.1 and 4 lbf/in. The hinge generates an adjustable tensile force that pulls inwards on the mounting bracket to generate a tensile force between the inner blade and the outer blade. The force applied to the snap tabs of the hinge changes a tensile force of the mounting bracket and adjusts a position of the inner blade relative to the outer blade.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a hair cutting device, according to an exemplary embodiment.

FIG. 2 is a top perspective view of a blade assembly with a mounting bracket coupled to a metallic hinge, according to an exemplary embodiment.

FIG. 3 is an exploded view of the blade assembly of FIG. 2, illustrating how the metallic hinge couples to the mounting bracket, according to an exemplary embodiment.

FIG. 4 is a perspective exploded view of the blade assembly of FIG. 2, according to an exemplary embodiment.

FIG. 5 is a side perspective view of the blade assembly of FIG. 2, according to an exemplary embodiment.

FIG. 6 is a side view of the blade assembly of FIG. 2, according to an exemplary embodiment.

FIG. 7 is a top perspective view of the blade assembly of FIG. 2, according to an exemplary embodiment.

### DETAILED DESCRIPTION

Referring generally to the figures, various embodiments of hair cutters or clippers are shown. The cutters include a blade assembly with an upper or inner blade that oscillates over a lower or outer blade to cut or trim hair. The alignment of the inner blade relative to the outer blade creates competing objectives. The inner blade and outer blade need to be close enough to each other to cut hair when the inner blade teeth oscillate over the outer blade teeth. However, pressing the inner blade against the outer blade creates friction between the blades as they oscillate relative to one another. The inner and outer blade should be pulled together so that the oscillation of the inner and outer teeth do not interfere with the cutting ends of the blades. The blades should be pulled apart to reduce friction. Proper tensioning between the blades reduces friction on the system, wear and tear on the blades, and enhances the operational life of the motor. Balancing the tensile force that separates the inner blade from the outer blade with an attractive force that captures the inner blade relative to the outer blade both enhances the operation of the blade and ensures the teeth cooperate to cut hair.

For ease of discussion and understanding, the following detailed description will refer to and illustrate the blade assembly that incorporates magnetic tensioning and/or blade set adjustment in association with a hair cutting apparatus or “cutter.” It should be appreciated that a “cutter” is provided for purposes of illustration, and the blade assembly disclosed herein can be used in association with any hair cutting, hair trimming, or hair grooming device. Accordingly, the term “cutter” is inclusive, and refers to any hair grooming device including, but not limited to, a hair trimmer, a hair clipper, or any other hair cutting or hair grooming device. The cutter device can be suitable for a human, animal, or any other living or inanimate object having hair.

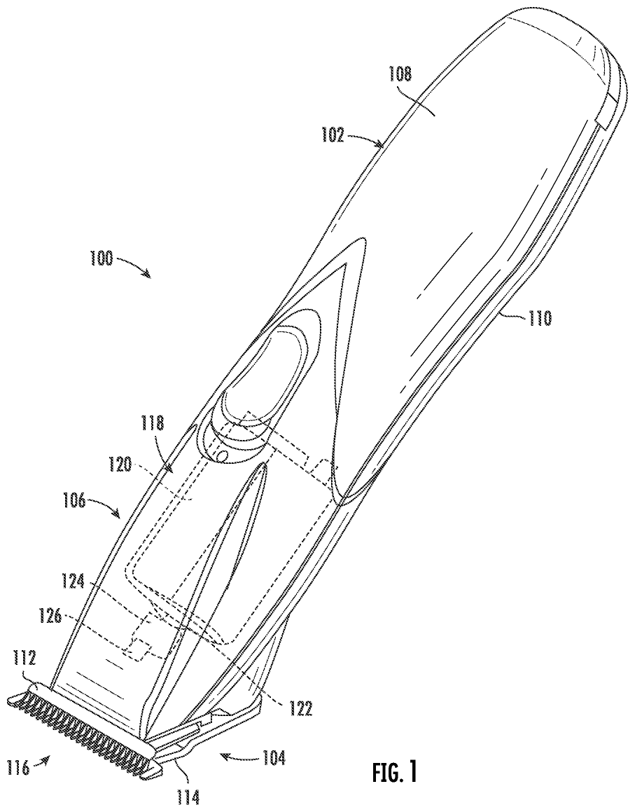

FIG. 1 illustrates an example embodiment of a hair cutting apparatus, trimmer, clipper, or cutter 100. Cutter 100 includes a body 102, a blade set or blade assembly 104, and a drive assembly 106. As illustrated in FIG. 1, body 102 is hand-held and includes a clamshell configuration of two portions: a first or upper housing 108 and a second or lower housing 110 (e.g., on a top and bottom of cutter 100). Cutter 100 body 102 may include other configurations. For example upper housing 108 and/or lower housing 110 form a single integral body 102 or component part. Body 102 could join housing 108 and/or housing 110 in other clamshell configurations (e.g., from one or more sides) and may include additional parts on the top, bottom, sides, or ends of body 102. Blade assembly 104 includes a translating, upper, or inner blade 112 and a stationary, lower, or outer blade 114. Body 102 and housing 108 and/or 110 define a cutting end 116 that includes blade assembly 104. Body 102 further defines a cavity 118 to support a motor 120. As illustrated in FIG. 1, cavity 118 is formed from the clamshell configuration of upper housing 108 and lower housing 110 such that body 102 surrounds drive assembly 106 and motor 120 coupled to blade assembly 104.

Drive assembly 106 is positioned within cavity 118 and couples blade assembly 104 to motor 120. As illustrated, motor 120 is a rotary DC electric motor. In other embodiments, motor 120 is a pivot motor or a magnetic motor that generates oscillating or reciprocating movement for blade assembly 104 (e.g., drive assembly 106 couples to inner blade 112 to oscillate inner blade 112 over a stationary outer blade 114). In other embodiments, motor 120 is an AC electric motor or any other suitable motor for generating oscillating or reciprocating movement for a blade assembly 104, e.g., inner blade 112 and/or outer blade 114. As illustrated, motor 120 is configured to operate on battery power (e.g., cordless), but may be configured to operate with electricity from any suitable electric source, e.g., a corded cutter 100 plugged into an outlet.

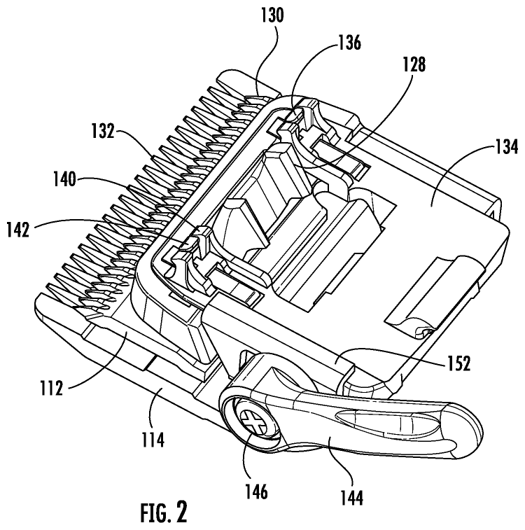

Motor 120 couples to a rotating motor output shaft 122 that rotates about a rotational axis. An eccentric drive 124 is coupled to motor output shaft 122 and rotates eccentrically about the rotational axis. Eccentric drive 124 includes an eccentric shaft 126 that is offset from motor output shaft 122. In other words, eccentric shaft 126 is offset from the axis of rotation of motor 120, such that eccentric shaft 126 rotates non-concentrically around the axis of rotation to create an oscillatory rotational motion. Eccentric shaft 126 is configured to engage a yoke 128 (FIG. 2) of blade assembly 104 and translate or oscillate inner blade 112 linearly. Blade assembly 104 is coupled to cutting end 116 of the body 102. For example blade assembly 104 may couple to body 102 with an adhesive, a rivet, a weld, a bolt, a screw, or at least one or more fasteners.

As illustrated in FIG. 2, inner blade 112 has inner blade teeth 130 and outer blade 114 has outer blade teeth 132 oriented parallel to inner blade teeth 130. The inner blade teeth 130 are configured to oscillate over the outer blade teeth 132 when inner blade 112 oscillates over outer blade 114 to facilitate cutting. Blade assembly 104 further includes a blade attachment or mounting bracket 134 and a hinge, metal stamping, or biasing spring 136 that extends from an inner surface 138 of inner blade 112 through mounting bracket 134 and to an alignment tab 140 (e.g., a plastic tab 140). Biasing spring 136 further includes a snap tab 142 that cooperates with tab 140 on mounting bracket 134 to adjust inner blade 112 relative to outer blade 114. Mounting bracket 134 is coupled to an inner surface 138 of inner blade 112 and is configured to press inner blade 112 against outer blade 114 to capture inner blade 112 there between.

In some embodiments, a lever 144 is coupled to blade assembly 104 with a screw or fastener 146. Lever 144 facilitates movement of inner blade 112 over outer blade 114 in a direction perpendicular to the blade teeth 130 and/or 132. This adjustment of the inner blade teeth 130 relative to the outer blade teeth 132 adjusts the length of hair cut by the inner and outer blades 112 and 114.

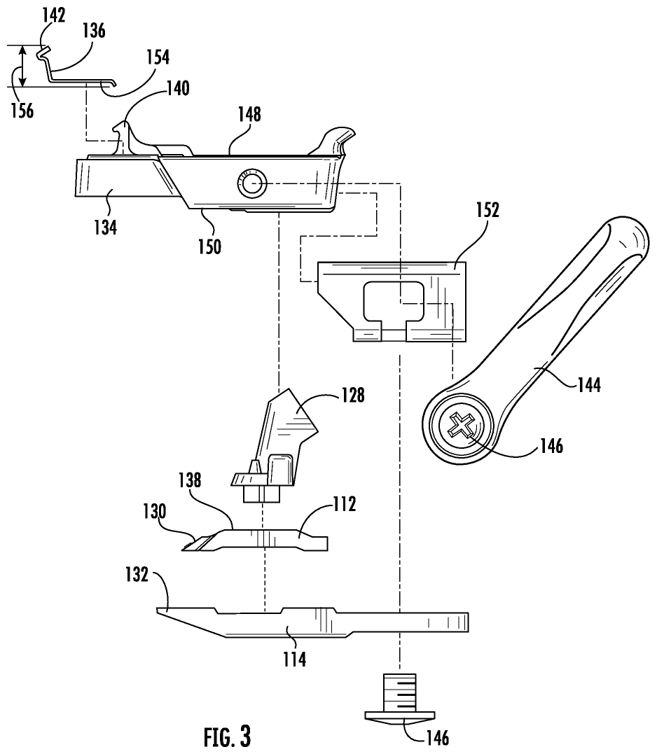

FIG. 3 illustrates a side view of the exploded blade assembly 104 shown in FIG. 2. Biasing spring 136 includes snap tabs 142 (e.g., a pair of snap tabs 142) that couple to alignment tabs 140 on the mounting bracket 134. In other words, biasing spring 136 attaches to an inner surface 138 of inner blade 112 and an inner surface 148 of mounting bracket 134 to adjust the pressure the mounting bracket 134 applies to inner blade 112. Biasing spring 136 passes through mounting bracket 134 from an outer surface 150 of mounting bracket 134 (adjacent to inner surface 138 of inner blade 112) to an inner surface 148 of mounting bracket 134. This configuration enables biasing spring 136 to adjust the attractive or tensile force between inner blade 112 and the mounting bracket 134. In the illustrated embodiment, snap tabs 142 on biasing spring 136 are oriented to be coplanar with alignment tabs 140 on mounting bracket 134. A retainer 152 couples to mounting bracket 134 and orients mounting bracket 134 relative to blade assembly 104 (FIG. 1).

This adjustment proportionally changes the attractive or tensile for between inner blade 112 and outer blade 114. Thus, changing biasing spring 136 (e.g., pushing snap tabs 142) draws the mounting bracket 134 closer to inner blade 112 creating an attractive force between the blades 112 and 114 (e.g., reducing the tensile force). Pulling snap tabs 142 draws the mounting bracket 134 away from inner blade 112 creating a tensile force between the blades 112 and 114 (e.g., separating inner bald 112 from outer blade 114). In this way, biasing spring 136 provides adjustment to the force between the inner and outer blades 112 and 114. In some embodiments, a fastener 146 couples to inner blade teeth 130 that captures mounting bracket 134 relative to the blade assembly 104.

For example, snap tabs 142 of biasing spring 136 extend through mounting bracket 134. A base 154 (e.g., outer surface) of biasing spring 136 is coupled to inner blade 112. Adjustments or changes to an offset 156 (FIG. 6) measured from base 154 to snap tabs 142 of biasing spring 136 proportionally changes the attractive or tensile forces between inner and outer blades 114 and 114. Biasing spring 136 is a relatively ductile material relative to mounting bracket 134, which is designed to be a lightweight firm or rigid material that captures inner blade 112. In some embodiments, biasing spring 136 is metallic material or alloy (e.g., a base alloy comprising aluminum, titanium, or steel) and mounting bracket 134 is a polymer, plastic, fiber composite, or thermoset material. Biasing spring 136 has a ductile property that enables permanent deflection with a resulting spring constant of between 0.1 and 4 lbf/in. In various embodiments, biasing spring 136 has a spring constant between 0.1 and 4 lbf/in, specifically between 0.2 and 2 lbf/in, and more specifically between 0.5 and 2 lbf/in. Stated differently, spring 136 has a spring rate of between 0.25 and 10 in/lbf, specifically between 0.5 and 5 in/lbf, and more specifically between 0.5 and 2 in/lbf. Because biasing spring 136 may comprise a ductile material, permanent deflection of biasing spring 136 enables a variable force between inner blade 112 and mounting bracket 134, which results in a variable force between inner and outer blades 114 and 114. In some embodiments, the permanent deflection of biasing spring 136 results in a variable or adjustable spring constant.

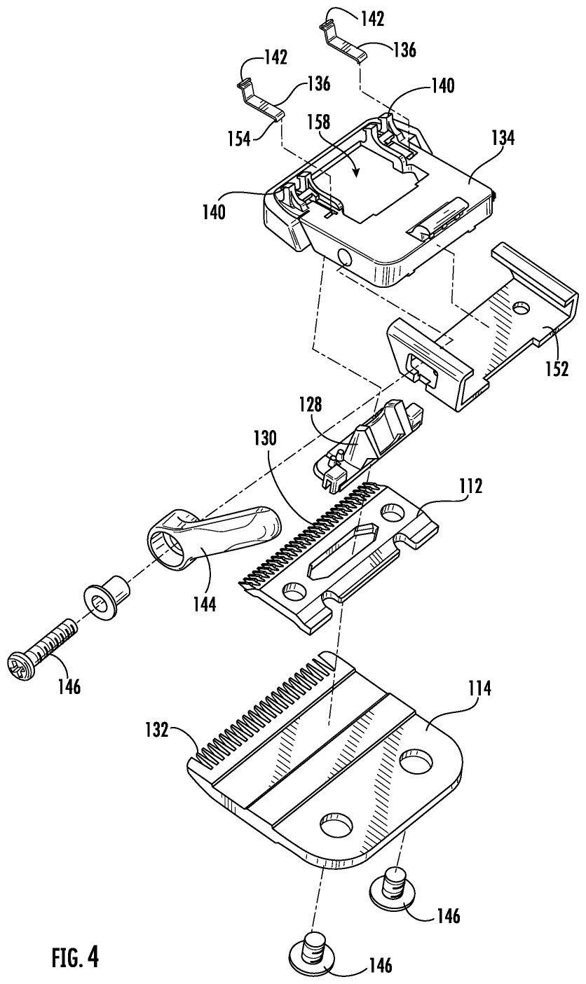

FIG. 4 is an exploded perspective view of the blade assembly 104 of FIG. 2. As shown in FIG. 4, biasing spring 136 passes through mounting bracket 134 to align snap tabs 142 of biasing spring 136 adjacent to plastic tabs 140 of mounting bracket 134. In some embodiments, biasing spring 136 is press fit into a plastic mounting bracket 134 (e.g., a blade attachment). In some embodiments, biasing spring 136 is molded into a plastic mounting bracket 134. As shown in FIG. 4, the inner blade teeth 130 can serve as a mechanism to couple inner blade 112 to biasing spring 136 and/or mounting bracket 134. In some embodiments, metallic snap tabs 142 of biasing spring 136 can be adjusted (e.g., pulled) to increase the tensile force between inner blade 112 and outer blade 114 by 5%, 10%, 15%, 20%, or more. Similarly, metallic snap tabs 142 of biasing spring 136 can be adjusted (e.g., pushed) to decrease the tensile force (e.g., increase the attractive force) between inner blade 112 and outer blade 114 by 5%, 10%, 15%, 20%, or more.

In some embodiments, biasing spring 136 is coupled to inner blade 112 and/or inner blade teeth 130. For example, biasing spring 136 may be brazed, spot welded, and/or fastened (e.g., with screws or fasteners 146) to inner blade 112 and/or inner blade teeth 130. This enables biasing spring 136 to couple to the retaining bracket directly in a non-oscillatory position, or to oscillate with inner blade 112 and create a spring or biasing force on the mounting bracket 134.

With reference to FIGS. 3 and 4, snap tabs 142 protrude out to form a proximate end of biasing spring 136. Snap tabs 142 extend through and beyond mounting bracket 134 to provide an adjustment surface that can be pushed or pulled to change the forces between biasing spring 136 and the mounting bracket 134, which adjusts the attractive and/or tensile forces between the inner and outer blades 114 and 114.

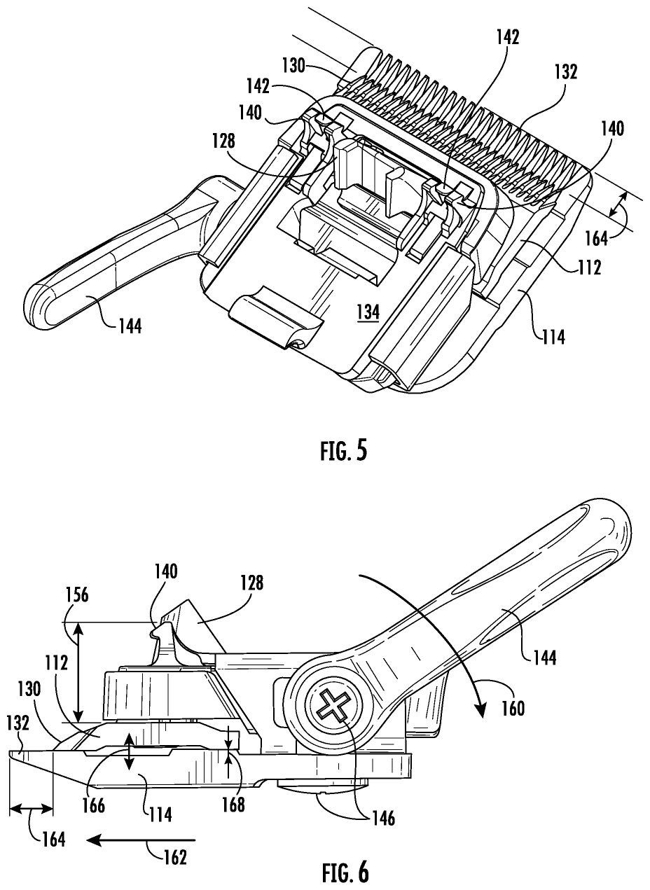

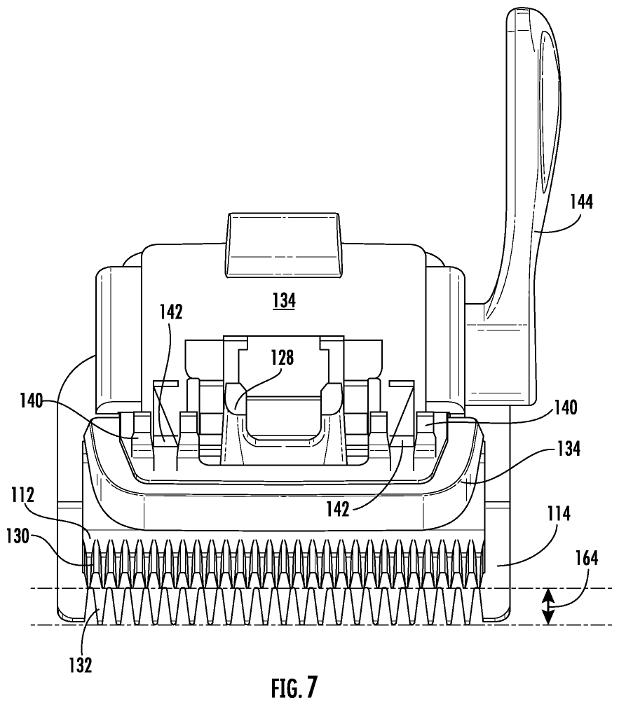

FIGS. 5-7 illustrate different perspective views of the blade assembly 104. As shown, a yoke 128 couples to eccentric shaft 126 of eccentric drive 124 to oscillate inner blade 112. Yoke 128 oscillates in an opening 158 (FIG. 4) between tabs 140 of mounting bracket 134. In this way, the drive assembly 106 couples to blade assembly 104 via yoke 128 coupled to inner blade 112 through opening 158. Rotating lever 144 in a clockwise direction 160, as shown in FIG. 6, will move inner blade 112 over outer blade 114 in a linear direction 162. Similarly, rotating lever 144 in a counter clockwise direction opposite direction 160 will move inner blade 112 over outer blade 112 in a linear direction opposite direction 162. A gap 164 between an outer surface of outer blade 114 and the inner blade teeth 130 changes as inner blade 112 moves in the linear direction 162 shown. In this way, lever 144 is adjusted to control a length of hair. Similarly, snap tabs 142 can be pushed or pulled over alignment tabs 140 to increase or decrease tensile force 166 (or attractive force 168) between inner blade 112 and outer blade 114.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

What is claimed is:

1. A blade hinge assembly, comprising:
an inner blade comprising blade teeth;
an outer blade comprising blade teeth oriented parallel to the inner blade teeth and configured to facilitate cutting when the inner blade oscillates over the outer blade;
a mounting bracket comprising tabs, the mounting bracket coupled to an inner surface of the inner blade and configured to press the inner blade against the outer blade; and
a metallic stamping coupled to the inner surface of the inner blade and extending through the mounting bracket and adjacent to the tabs, the metallic stamping comprising snap tabs configured to couple to the tabs of the mounting bracket, wherein the snap tabs couple with tabs to generate an adjustable tensile force that pulls the mounting bracket away from the inner blade.

2. The blade hinge assembly of claim 1, wherein the metallic stamping is press fit into the mounting bracket.

3. The blade hinge assembly of claim 1, wherein the metallic stamping is molded into the mounting bracket.

4. The blade hinge assembly of claim 1, wherein the snap tab increases the tensile force between the inner blade and the outer blade by 5% or more.

5. The blade hinge assembly of claim 1, wherein the snap tab decreases the tensile force between the inner blade and the outer blade by 5% or more.

6. The blade hinge assembly of claim 1, wherein the snap tab on an end of the metallic stamping extends beyond the mounting bracket, the snap tab configured to provide a surface to adjust the force between the metallic stamping and mounting bracket and thereby adjust the tensile force between the inner blade and outer blade.

7. The blade hinge assembly of claim 1, wherein the metallic stamping is brazed onto the inner surface of the inner blade.

8. The blade hinge assembly of claim 1, further comprising fasteners that fasten the inner blade to the metallic stamping.

9. The blade hinge assembly of claim 1, wherein the snap tabs of the metallic stamping extend through the mounting bracket and a base of the metallic stamping is coupled to the inner blade, wherein changing an offset measured from the base to the snap tabs of the metallic stamping proportionally changes the tensile force between the inner blade and the outer blade.

10. A blade attachment assembly, comprising:
an inner blade comprising a plurality of blade teeth;
an outer blade comprising a plurality of blade teeth;
a mounting bracket comprising plastic tabs, the mounting bracket coupled to an inner surface of the inner blade and pressing the inner blade towards the outer blade to capture the inner blade; and
a hinge coupling an inner surface of the inner blade to an inner surface of the mounting bracket with snap tabs, the hinge comprising a spring constant between 0.1 lbf/in and 4 lbf/in, wherein adjustment of the snap tabs against the plastic tabs on the mounting bracket changes a tensile force applied to the mounting bracket to adjust a position of the inner blade relative to the outer blade.

11. The blade attachment assembly of claim 10, wherein the hinge is adjustable to change the tensile force between the mounting bracket and the inner blade.

12. The blade attachment assembly of claim 10, wherein the hinge is a metal stamping that is press fit into the mounting bracket.

13. The blade attachment assembly of claim 10, wherein the hinge is a metal comprising an alloy of at least one of an aluminum, a titanium, or a steel.

14. The blade attachment assembly of claim 10, wherein the hinge changes the tensile force generated by the mounting bracket 5% or more.

15. The blade attachment assembly of claim 10, further comprising a tab on an end of the hinge, wherein the tab extends beyond the mounting bracket and provides a movable surface configured to adjust the force between the hinge and the mounting bracket that adjusts the tensile force between the inner blade and outer blade.

16. The blade attachment assembly of claim 15, further comprising a base of the hinge that is coupled to the inner blade, wherein changing an offset measured from the base to the tab of the hinge proportionally changes the tensile force between the inner blade and the outer blade.

17. An adjustable blade attachment assembly, comprising:
an inner blade comprising blade teeth;
an outer blade comprising blade teeth oriented parallel to the inner blade teeth and configured to facilitate cutting when the inner blade oscillates over the outer blade;
a mounting bracket comprising plastic tabs, the mounting bracket coupled to an inner surface of the inner blade and pressing the inner blade towards the outer blade to capture the inner blade; and
a metallic stamped hinge that couples an inner surface of the inner blade to an inner surface of the mounting bracket with snap tabs that couple to the plastic tabs of the mounting bracket, the hinge comprising a spring constant between 0.1 lbf/in and 4 lbf/in to generate a force that pulls the mounting bracket inwards and generates a tensile force between the inner blade and the outer blade, wherein adjustment of the snap tabs on the hinge changes a tensile force applied to the mounting bracket to adjust the inner blade relative to the outer blade.

18. The adjustable blade attachment assembly of claim 17, wherein the snap tabs on an end of the metallic stamped hinge extend beyond the mounting bracket and are configured to provide a movable surface to adjust the force between the hinge and the mounting bracket that adjusts the tensile force between the inner blade and outer blade.

19. The adjustable blade attachment assembly of claim 18, further comprising a base of the metallic stamping coupled to the inner blade, wherein changing an offset measured from the base to the snap tab of the hinge proportionally changes the tensile force between the inner blade and the outer blade.

20. The adjustable blade attachment assembly of claim 19, wherein the snap tabs on the hinge are oriented to be coplanar with the plastic tabs of the mounting bracket.
